(19) United States
(12) Patent Application Publication
(10) Pub. No.: US 2020/0073765 A1
(43) Pub. Date: Mar. 5, 2020

(54) DISTRIBUTED BACKUP AND PRECISE RECOVERY FOR CONSISTENT HASHING SYSTEMS

(71) Applicant: Ashish Tanwer, (US)

(72) Inventors: Ashish Tanwer, SUNNYVALE, CA (US); Nisha Kumari, SUNNYVALE, CA (US); Neelesh Tanwar, SUNNYVALE, CA (US)

(21) Appl. No.: 16/120,333

(22) Filed: Sep. 3, 2018

(51) Int. Cl. G06F 11/14

(52) U.S. Cl. CPC G06F 11/1474; G06F 2201/84; G06F 11/1464; G06F 11/1469

(57) ABSTRACT

The innovation is the design of an efficient network-based distributed storage backup, versioning, and point-in-time recover solution for consistent hashing based distributed systems. The solution works on the principle of periodically snapshotting of the system on a backup medium and the centralized transaction recording. The patent covers the implementation details of Cassandra, distributed DBMS based on consistent hashing architecture. The current innovation allows reducing latency and bandwidth consumption during backup and allows fine-grain point-in-time recovery with fast convergence by removing the need to duplicate computing work already done before the crash. The solution is designed to address backup node cost concerns, backup space cost concerns and operation time concerns. The solution has high availability, reliability, and fidelity to continuous back with little running overhead and safely and efficiently recover data during a crash.

### REFERENCE CITED

### U.S. Patent Documents

Nov. 30, 2006 US20060271604A1 Shoens, Kurt
Jun. 28, 2012 US20120166394A1 KIM, Mi-Jeom; Park, Chang-Sik; Lee, Eo-hyung;
Aug. 8, 2013 US20130204849A1 Chacko, Peter
Feb. 20, 2014 US20140052700A1 VanderSpek, Adrian; Poirier, Jamey C.; Makosky, Lucas H.;
Jul. 31, 2014 US20140215057A1 Walsh, Alexander Leonard; Spraggins, Daniel Joseph
Feb. 16, 2010 U.S. Pat. No. 7,664,771B2 Kusters, Norbert P.; Leis, Benjamin A.; Zbikowski, Mark J.
Jan. 29, 2013 U.S. Pat. No. 8,364,648B1 Sim-Tang, Siew Yong
Jul. 29, 2014 U.S. Pat. No. 8,793,343B1 III, James Christopher Sorenson; Lin, Yun
Feb. 7, 2017 U.S. Pat. No. 9,563,517B1 Natanzon, Assaf; WEISS, Eran
Oct. 16, 2008 US20080256138A1 Sim-Tang, Siew Yong
Jun. 28, 2012 US20120166403A1 KIM, Mi-Jeom; Kim, Hyo-Min; Lee, Eo-hyung; Hwang, Jin-Kyung
Oct. 10, 2013 US20130268740A1 Holt, Gregory
Feb. 27, 2014 US20140059551A1 Umanesan, Ganesan
Sep. 18, 2014 US20140280433A1 Messerli, Antony; Voccio, Paul
Mar. 30, 2010 U.S. Pat. No. 7,689,602B1 Sim-Tang, Siew Yong
Mar. 19, 2013 U.S. Pat. No. 8,401,997B1 Tawri, Deepak; Karr, Ronald S.; Colgrove, John A.;
Sep. 2, 2014 U.S. Pat. No. 8,826,279B1 Pacheco, David; Cavage, Mark; Xiao, Yunong; Cantrill, Bryan
Oct. 28, 2010 US20100274765A1 Murphy, Elissa E. S.; Virk, Navjot
Sep. 13, 2012 US20120233134A1 Barton, Michael; Reese, Will; Dickinson, John A.; Payne, Jay B.
Oct. 31, 2013 US20130290361A1 Anderson, Eric A.; Wylie, John Johnson; Tucek, Joseph A.
Mar. 13, 2014 US20140075557A1 Balabine, Igor; Velednitsky, Alexander
Jun. 28, 1994 U.S. Pat. No. 5,325,528A Klein, Johannes
Sep. 14, 2010 U.S. Pat. No. 7,797,283B2 Fachan, Neal T.; Passey, Aaron J.; Schack, Darren P.
Jun. 25, 2013 U.S. Pat. No. 8,473,526B2 Zlotnick, Aviad
Aug. 18, 2015 U.S. Pat. No. 9,110,965B1 Shah, Kushal; Chatur, Makarand; Deshmukh, Manav;
Apr. 14, 2011 US20110087792A2 Wayda, James; Rodriguez, Elizabeth; Lee, Kent
Sep. 13, 2012 US20120233522A1 Barton, Michael; Reese, Will; Dickinson, John A.; Payne, Jay B.;
Nov. 21, 2013 US20130311612A1 Dickinson, John A.
Apr. 17, 2014 US20140108474A1 David, Goetz; Holt, Gregory Lee
Jul. 26, 1994 U.S. Pat. No. 5,333,314A Masai, Kazuo; Wakayama, Satoshi; Yamamoto, Shoji;
Sep. 6, 2011 U.S. Pat. No. 8,015,211B2 Marceau, Carla; Stillerman, Matthew A.
Dec. 31, 2013 U.S. Pat. No. 8,620,879B2 Cairns, Ryan
Apr. 26, 2012 US20120102291A1 Cherian, Jacob; Chawla, Gaurav
Feb. 14, 2013 US20130041872A1 AIZMAN, Alexander; Bestler, Caitlin
Dec. 5, 2013 US20130325950A1 Laden, Guy; Melamed, Roie
May 29, 2014 US20140149794A1 Shetty, Sachin; Sankar, Krishna; Jassal, Amrit; Patel, Kalpesh;
May 13, 1997 U.S. Pat. No. 5,630,047A Wang, Yi-Min
Jan. 31, 2012 U.S. Pat. No. 8,108,429B2 Sim-Tang, Siew Yong; Fraisl, Daniel J.
Jan. 7, 2014 U.S. Pat. No. 8,626,793B2 Cameron, Donald F.; Strickland, Dancil C.
Mar. 29, 2016 U.S. Pat. No. 9,298,723B1 Vincent, Pradeep
May 10, 2012 US20120117320A1 Pinchover, Yishai Baruch; Mandel, Ron
Jul. 18, 2013 US20130185258A1 Bestler, Caitlin; AIZMAN, Alexander
Feb. 6, 2014 US20140040197A1 Wijayaratne, Ravi; Koos, Remus; White, Ray; Marathe, Manish;
Jul. 31, 2014 US20140214915A1 Dragon, Monsyne Michael; Walsh, Alexander Leonard;
Apr. 18, 2000 U.S. Pat. No. 6,052,695A Abe, Kenichi; Imafuku, Yukiharu; Kirita, Hitoshi;
Jan. 8, 2013 U.S. Pat. No. 8,352,941B1 Protopopov, Boris; Leschner, Jurgen
Sep. 27, 2016 U.S. Pat. No. 9,454,318B2 Zhu, Ming Benjamin; Patterson, R. Hugo; Li, Kai

### FIELD OF THE INVENTION

The disclosed system relates generally to distributed cloud computing platforms and applications, and more specifically providing scalable distributed backup and recovery solution for Consistent Hashing or Distributed Hash Table systems.

### BACKGROUND

With the upsurge of computing devices like workstations, laptops, mobile and smart devices, and evolution of “internet of things”, the amount of data generated is increasing exponentially and the storage requirements are skyrocketing. On the one hand, there are technical limitations to increase the storage per unit, to increase storage units per device, to perform read, write or updates in a timely manner as the storage per device increases, and to reliably store and recover data in case of device failure. On the other hand, data communication rates, whether on local area network or internet are increasing at a fast pace. As the vertical scaling of storage is not economically feasible and possible after some limits, horizontal scaling is the only solution. The situations are ideal for the rise of distributed systems for storage and Cloud Storage and Big Data technologies are becoming more prominent. With the advancement of distributed storage systems, there is a need to need to develop and improve complementary distributed backup and recovery solution architecture. Network speed related enhancements have enabled to backup or revert from a different a LAN, WAN, or internet site.

Current Backup and Recovery solutions allow Backup to one or more new devices and recovering from them. With the large volume of data in distributed storage, the current methods will not be scalable. A new network or cloud backup system is required to backup and restore from a distributed storage system. It will be more cost-effective, reliable, resilient to disk or device crash, scalable and almost as fast as a traditional local backup. However, the tradeoff is the high network bandwidth requirement to backup each version or snapshot or the data.

Distributed consistent hashing systems like Cassandra are designed to be fault tolerant and resilient to the system and network failures. Current, distributed storage systems maintain N replicas of same data where N is the called replication factor for the cluster. Maintaining multiple replicas allow recovery when a few devices or nodes crash depending on the replication factor. Most distributed storage systems are eventually consistent or on the AP side in CAP theory. This allows such systems to recover when a data-center is down or during a network outage or partition without much efforts. But not much attention was given to design a distributed storage system that inherently has optimized network or cloud-based backup solution and point-in-recovery solution to reverted to a previous version in case of an unavoidable situation.

In most distributed consistent hashing systems, when there are more nodes crashed than the replication factor of the cluster, the data loss is imminent. Data in such systems can also get altered and tempered during cyber and hacking attacks. So, despite most distributed consistent hashing being very resilient in nature, there is an inherent need for a distributed backup and recovery solution for fault tolerance. Distributed point-in recovery will provide a guarantee of recovery in case of complete system failures like hacking, attacks, and the mistakes by application layer and by users/apps.

The traditional distributed backup and recovery solutions are very primitive in nature. They allow reverting back to point where the backup was taken and there is no way to revert to the desired point in time. A partial backup functionality can be achieved with versioned objects or snapshotting. But the recovery in the case of versioned objects has large storage implications and snapshotting is limited to recovery of snapshots and loss of data between snapshots. A partial point-in recovery functionality for mutations can be achieved by sending delete traffic corresponding to the mutation (write, modify, delete) traffic but the most distributed consistent hashing systems do not have a precise accounting of the input traffic. There is no way to do point-in recovery for delete traffic and contents are lost forever. The application layer generally takes care of making sure the traffic is correct. Sometime the application layer may provide some recovery functionality by delay delete traffic. As there is no internal architecture and mechanisms to the basic functionalities, most of such systems are very slow and network bandwidth extensive and require a lot of computing resources.

The design of distributed backup and recovery solutions has some fundamental problems to overcome. Most consistent hashing systems are in a constant state of flux of data where replicas constantly change location depending on storage load and available storage space. When the load is low some nodes are switched off and when the load is high more nodes are added. Merely, snapshotting and taking the backup of each node and revert it back up for recovery can give system in the completely different state. All these movements of replicas and optimizations need to be redone that takes significant computing resources and redoing all work is not only very extensive but also sometimes not possible which can lead to the unrecoverable or broken system.

The various algorithms decide the location of the data like number and arrangement of the data nodes (datacenters, clusters, PODs), number, arrangement and RAID type of the disks, disk capacity and failures avoidance, replication factory of data, storage load balancing. Various algorithms work to load balance between data centers in a cluster. Algorithms try to keep different data on different disks on a node and on different disk partition for better data recovery in case of a crash. Also, algorithms try to balance storage node between high storage capacity nodes and low storage capacity nodes so that no node gets filled. In case of node failures, the data is shifted to other nodes in a proportional manner and moves back when the node comes back online, or a new data node is added.

The design considers it is not possible to support a maintain a separate duplicated Data Center in the cluster with all nodes mirrored, due to high hardware cost and maintenance cost. The presented design utilizes minimum additional hardware resources (disks, nodes), adding minimum latency to the traffic and the shortest and fastest path to the desired point-in-time recovery wasting minimalistic computing resources.

The primary reason for the same is clouds is considered safer and operate even when some parts of the cloud are down. The second reason is cloud needs distributed backup solutions, that are very hard to design. These solutions are required to prevent data loss in several adverse cases, like hacking, or DDOS attacks or the cases where input traffic is flawed or compromised.

Most solutions available in the market are very primitive and are specialized for the cloud implementation. There are fundamental problems with current solutions

1 Backup Space: For distributed backup, every node in the system is required to be snapshotted and copied. It required a large amount of data to be generated copies, managed, and storage for each backup.

2 Recovery Time: The recovery time is too high due to large volumes of data and too much bandwidth requirements. Also, for the individual nodes, convergence time after recovery is high.

3 Recovery Precision: The cloud is only recovered to the last backup point and point close. But they cannot be precisely recovered to any point in time of interest.

4 Specialized Implementations: There are a variety of solutions developed speciated for every cloud type. There is no fit-all type solution available in the market.

Mainly, there are 2 types of distributed backup and recovery solutions available in the market.

Type A solutions rely on the cloning the cloud cluster in a second data center and then periodically syncing with the primary data center. These types of solution need twice the number of nodes, both computing and storage resources identical to the primary data center. These solutions provide low Recovery Time and somewhat Precise Recovery, at the trade-off of duplicating every node and resource like network and operation and thus doubling the Cloud management Cost. For clouds where the economy is concerned, Type A solutions are impractical due to very high cost. Solution Type A is used in subscription Clouds like Amazon AWS and Google Cloud Platform.

Type B solutions rely on the snapshotting every node and saving them on the remote Cloud Cluster. The solution requires complete all nodes backups again and again. Without computing resource, old backups cannot sync with the new backups like in solutions of Type A. These solutions provide a low-cost operation cost then of type A solutions and do not need every node to be duplicated like in Type A solutions. Type B solutions need very high Backup Space and are bandwidth extensive. The recovery time and recovery precision are also not good. The backup and recovery solution in OpsCenter manager for Cassandra is a Type B solution.

There are numerous end-devices backup and recovery solutions available in the market. But there is a scarcity of solutions designed for consistent hashing systems. There is no consistent hashing system backup and recovery solution in the market that can simultaneously address node cost concerns, backup space concerns with operation time concerns despite their very identical design.

### SUMMARY

Contrary of the traditional systems, current innovation is a completely new design that allows reducing latency and bandwidth consumption during backup and allows fine-grain point-in-time recovery with fast convergence by removing the need to duplicate computing work already done before the crash. The solution is a generic mechanism to recover to any point-in-time point granularly, not just the snapshotted versions without the computing overheads for moving and optimizing the data. It can also help to prevent data loss in several adverse cases, like hacking, or cyber-attacks like DDOS or the cases where input traffic is flawed or compromised. The primary use of the solution is to prevent data loss in several adverse cases, like hacking, or DDOS attacks or the cases where input traffic is flawed or compromised.

The patent covers the implementation details of three popular categories above with alternate design for most common system design variations. The drawings below explain the process of backup and recovery using the solution. Some components mention here by the same name, vary in functionality with cloud implementation change. Also, the workflow of the solution varies a bit with the platform implementation. Further details are provided in the patent document.

The current innovation is an enterprise-ready cloud backup and recovery solution that solves the high computing resource requirements, high storage requirements, high network bandwidth requirements, and very high recovery time. The solution is designed to be economical for computing, network, and storage resources while offering faster and precise point-in-time recovery. The solution is a very low operating cost performance impact. Theoretically, the system is 3 to 10 times cheaper than existing solutions.

Recovery precision is due to continuous transaction recording and not continuous journaling of the actual data of disks. Except for some highly optimized file system implementations, continuous journaling is not always a good solution. It takes a large amount of CPU resource and introduces latency. On the other hand, recovery precision due to the continuous transaction recording does not add any latency. The solution works principle of the periodic snapshotting of the data nodes. The Time to Live value of data in Transaction Cluster 201 is maintained more than the snapshotting internal of the data to successfully recover the data.

All these algorithms vary in cloud implementations and requirements. These algorithms take a significant amount of computing. My algorithm saves this compute work done by various services as transaction logs. Also, these transaction logs are periodically sent to the Transaction Cluster 201 where these logs are merged vectorially with the existing recorded transaction. As a result, during recovery when the data is sent back to the nodes, all the work done before the crash is need not to be redone.

The innovation is the design is an efficient and generic network-based distributed storage or cloud backup, versioning, and point-in-time recover solution. The solution works on the principle of periodically snapshotting the distributed system or cloud on a backup medium and the centralized transaction recording. It provides a very low operating cost and very low impact on the performance of the system.

### Problem Solved

1 Backup Space: The solution introduces a “Data Dereplicator 204” module that can reduce the reduce the backup data amount by the replication factor. There is “Data Deduplicator 205” module for in-process client-side deduplication to further decrease the size of full and incremental snapshots. The system is designed to be capable of 3× to 10× reduction in storage space.

2 Recovery Time: The solution mentioned in the innovation, finds the shortest path of recovery through the Transaction Cluster 201. “Transaction Compactor 208” and “Transaction Collection 209” components are constantly optimizing and reducing the path of recovery. Simplification of the transactions removes the need for duplicated work to be done after recovery saving a lot of computing on each node and extremely fast recovery time.

3 Recovery Precision: The solution has a Transaction Player 302 component that transforms the transaction back to request from. All the recorded transactions are timestamped and played/streamed in the timestamp order that allows precision in recovery and tolerance to any misconfiguration.

4 Specialized Implementations: The solution is modular in nature and most components are generic in nature making it compatible with a variety of cloud implementations. There are details on how to effectively implement cloud-specific platform-dependent modules. It always has a platform dependent module called Snapshotting and Cloning Module 203 (SCM) and patent covers enough details of its implementation SCM on various popular cloud Platforms.

### BRIEF DESCRIPTION OF DRAWINGS

FIG. 1 describes the Basic Architecture of Consistent Hashing or Distributed Hash Table Systems.

FIG. 2 describes the Backup Architecture in Distributed Consistent Hashing or Distributed Hash Table Systems and explained in detail in Backup Architecture section.

FIG. 3 describes the Recovery Architecture in the Distributed Consistent Hashing or Distributed Hash Table Systems and explained in detail in Recovery Architecture section.

FIG. 4 describes the process flow of the Backup Process of Distributed Consistent Hashing or Distributed Hash Table Systems and explained in detail in Backup Process section.

FIG. 5 describes the process flow of the Recovery Process of Distributed Consistent Hashing or Distributed Hash Table Systems and explained in detail in the Recovery Process section.

### DETAILED DESCRIPTION

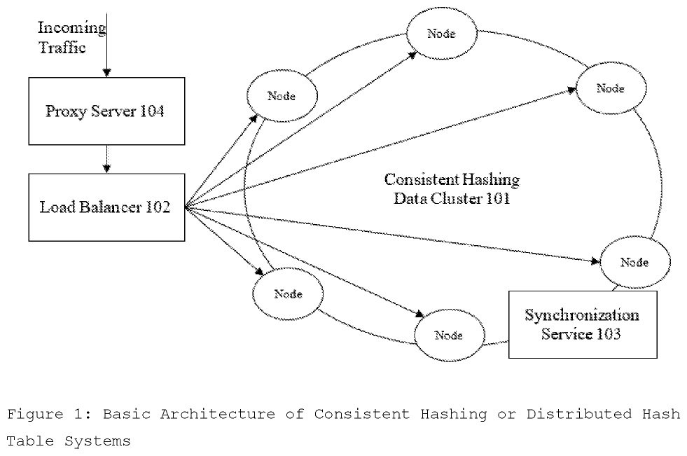

In Consistent hashing cluster implementation, every node in the cluster has the same role or can act as coordinator. There is no single point of failure. Data is distributed across the cluster (so each node contains different data), but there is no master node as every node can service any request. Replication strategies and factor are configured to satisfy desired consistency and resiliency. Often the cluster has multiple data centers which are mirror images of each other for redundancy, failover, and disaster recovery. Data is automatically replicated as defined by the replication factor to multiple nodes for fault-tolerance. In Consistent hashing cluster, there is no separate metadata cluster. There are no internal services in Data Cluster 101 to create journaling transactions. Some examples of consistent hashing and distributed hast table (DHT) are Apache Cassandra. Google Bigtable, Amazon Dynamo, and Apache CouchDB. FIG. 1 describes the Basic Architecture of Consistent Hashing System

Data Cluster 101 is a primary cluster that stores all the data and needs to be backup for disaster recovery. Data Cluster 101 consists of a set of Data Nodes each containing some computing resource, storage to store a part of the data of cluster and networking resources to communicate with other Data Nodes. Node storage consists of a set of hard disks HDDs, SSDs configured in hardware or software RAID or JBOD. The consistent hashing data storage file system (FS) can be a snapshotting File System, a Non-Snapshotting File System or as mutable or immutable payload on Host Operating System's File System.

Load Balancer 102 is an essential part of distributed systems. All the mutation (write, modify, delete) traffic and non-mutation (read, select, describe, count) traffic go to the load balancer 102 which distributes the traffic load among Data Cluster 101 nodes. NGINX is a very popular, high-performance Load Balancer 102, Web Server, & Reverse proxy solution. NGINX accelerates content and application delivery, improves security, facilitates availability and scalability for the busiest websites on the Internet. Nginx also provides Module ngx_http_mirror_module that implements mirroring of an original request by creating background mirror subrequests can be used for traffic recording as well. HAProxy, or High Availability Proxy, is another popular open source TCP/HTTP Load Balancer 102 and proxying solution. It is used to improve the performance and reliability of a server environment by distributing the workload across multiple distributed servers. DNS servers or the name-servers are used to get the address of the machines hosting a resource. Since DNS allow multiple records to be kept (even the same kind), it becomes possible to list multiple hosts as the server for High-Availability or for the role of layer 7 Load Balancer 102. Most common DNS servers like Bind provide the basic load-balancing like Round Robin DNS load-balancing.

Backup Architecture

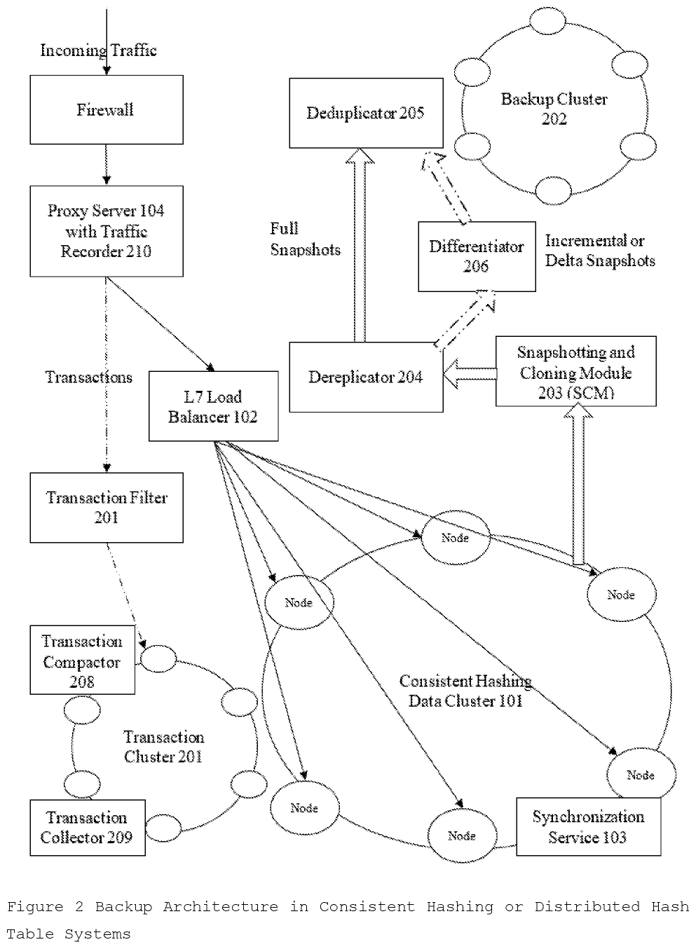

The Backup subsystem consists of two addition cluster, the Transaction Cluster 201 to store the live transactions, and the Backup Cluster 202 to store then backup snapshots in addition to the Data Cluster 101. It has components like Traffic Recorder 210, Transaction Filter 207, and Snapshotting and Cloning Module 203 (SCM), that are only present on the backup path. Other subsystem components like Data Dereplicator 204, Data Deduplicator 205 and Data Differentiation 206 have their counterparts in the Recovery subsystem. Transaction Cluster 201 has addition components Transaction Compactor 208 and Transaction Collector 209 for transaction simplification. FIG. 2 describes the Backup Architecture in Distributed Consistent Hashing or Distributed Hash Table Cluster.

In the Backup subsystem, Traffic Recorder 210 is a component that can perform real-time recording of the incoming Traffic. The traffic can be managed and controlled at the application layer by a proxy server 104 that can act as Traffic Recorder 210 with modification or with the plugin. Teeproxy is a layer 7 reverse HTTP proxy that can be used as Traffic Recorder 210. For each incoming request, it clones the request into 2 requests, forwards them to 2 servers. The result from server A is returned as usual, but the requests to server B can be saved as a transaction in the Transaction Cluster 201. teeproxy handles GET, POST, and all other HTTP methods. Another good Transaction recorder can be duplicator, a TCP proxy that also duplicates traffic to a secondary host. It is an agnostic duplicator and would require one open session per port and is used production systems for making CDN. Twitter's Diffy is a popular tool that acts as a proxy that accepts requests drawn from any source that you provide and multicasts each of those requests to different service instances. In one embodiment, Proxy Server 104, Traffic Recorder 210, or load balancer 102 can be in a single unit or multiple units.

The recorded transactions by the Traffic Recorder 210 are stored sequentially and then sent to Transaction Database Cluster 201 for storage and optimization by collecting away transaction no longer required and are not in transaction replay period. Transaction Cluster 201 is only required during a crash for Recovery. It can be economically designed Cluster or distributed Database solution as performance is not much concern. The Transaction Cluster 201 contains just the data between the distributed snapshots. For example, consider if Data Cluster 101 is consisting of data of last one year of recording on COS, and data nodes are snapshotted (avoiding delta vs incremental backup details for simplicity) every 6 hours, then the Transaction Cluster 201 will just have data of last 6+ hours like 12 hours. In the example, the Transaction Cluster 201 will have data=12 hours/8760 hours (1 year)=1/730 or the one 730th amount of data in the Data Cluster 101 assuming data is coming uniformly. It means for 1000 data nodes; 2 node Transaction Cluster 201 is enough.

In Backup subsystem, Transaction Filter 207 Module is used to separate mutation traffic (write, delete, updates) from the non-mutation (reads, select, describe, count) traffic. It takes input from the Traffic Recorder 210 and sends only mutation Transactions to the Transaction Cluster 201. It is essentially a Layer 7 filtering application firewall or Network Appliance. Application Layer traffic can be looked for Request Verb in a context like GET, POST, PUT or DELETE to filter out mutation traffic. In some embodiments, it is integrated with Traffic Recorder 210. It is beneficial to keep it separate as filtering may introduce some latency. For Example, 17-filter is a classifier for Linux's Netfilter subsystem which can categorize Internet Protocol packets based on their application layer data.

In the Backup subsystem, Transaction Compactor 208 used to compare data in Transaction Cluster 201 and remove redundancy or multiple values of each object. All the recorded transactions by Traffic Recorder 210 or by other services are in format or schema with essential fields like mutated object reference, the timestamp, and mutated object value and some additional metadata information and mutated object reference is selected as primary key or clustering key in distributed databases for sorting. When an object is deleted, the corresponding transaction has object value as null or some known token for identification. A single object in a Transaction Cluster 201 can have multiple object values at different timestamps. Transaction Compactor 208 compacts these multiple values of an object to a single value with latest timestamp value as the winner, simplifying records and reducing cluster size. Transaction Compactor 208 can work at the recording time of each transaction or at as periodically as service for better performance. In a hybrid approach, all transactions are sorted by object name in RAM for cache (called memtables), and when the RAM is filled, sorted memtables are flushed as Sorted string tables (on disk). Different memtables contains data coming from both transition recording of new data and transaction journaling of data changed by the internal services. SSTables contain outdated data, for example, different SSTables might contain both an old value and new value of the same data cell, or an old value for a cell later deleted. The Transition Compactor 208 compares and merges sorted string tables created by both types of memtables. The graph theory principles are used to analyze the final location and state (value) of the record. All the transactions are time-stamped, and a directed graph is built to solve the problem of compacting (A->B, A->C, B->C) type problem. The outcome is decided based on precise timestamps. Timestamps on each value or deletion are used to figure out which is the most recent value. The technique used for keeping sorted files and merging them is called the Log-Structured Merge (LSM) tree. It does not need reading entire SSTables into memory and requires mostly sequential disk reads. It is popularly used in Lucene search engine and Cassandra database. The solution uses very accurate NTP or PTP time sync by Synchronization Service 103 to avoid any data corruption.

In the Backup subsystem, Transaction Collector 209 is used to get rid of the old data that has been already saved by snapshots. All the recorded transactions by Traffic Recorder 210 are set to expire after a specific time generally in multiple of snapshotting interval. The time after which a transaction will expire is called GC grace value or TTL value. Transactions are also marked expired or deleted by Transaction Compactor 208 during the cluster compaction. Transaction Collector 209 compacts away old, GC/TTL expired transactions periodically at specialized triggers for better performance. In one embodiment, Transaction Compactor 208 and Transaction Collector 209 can be a single unit. The merged snapshot followed by precise transaction replay can recover the cluster at any desired point of time. The data is the transition cluster get deleted by Transaction collector 209 during the collection stage due to the expired TTL value, which is generally set a positive multiple of snapshotting internal of the Data Cluster 101. After the snapshot recovery is complete, transaction Player 302 migrates the data from the Transaction Cluster 201, transform it to the original request format and then streams back to the Data Cluster 101 in the order of the transaction timestamp.

The generated backup version or backup snapshot (full, incremental or deltas) are stored in the separate Backup Cluster 202. Cloud-based Backup Cluster 202 with cheap disk space like Glacier can act as a great alternative to the local Backup Cluster 202. The desired number of generated versions to be retained in the Backup Cluster 202 maintained locally or in the cloud. Just like Transaction Cluster 201, it is only required during a crash for Recovery. So, it can be economically designed Cluster or distributed Database solution as performance is not much concern.

In the Backup subsystem, Snapshotting and Cloning Module 203 (SCM) is responsible for taking a snapshot of the medium and cloning the snapshotted version to a local or remote location for storage. Cloning module facilitates creating a clone of data storage based on the point-in-time version of data storage or the snapshotted version. For different types of the storage mediums, there are different functionalities of SCM.

During snapshotting, journaling, recovering, and replaying all the data need to be precisely synchronized by Synchronization Service 103. All the nodes are synchronized with local NTP server. The NTP stratum 2 clock servers have sub-millisecond accuracy and stay coordinated with its stratum 1 servers with less than 200 microseconds offset. Stratum 3 or below can have sub-millisecond accuracy and can be inaccurate enough to create a problem in distributed systems. For higher accuracy, Precision Time Protocol (PTP) is preferred over NTP. PTP protocol used to synchronize clocks throughout a computer network and distributed solutions. On a local area network, it achieves clock accuracy in the sub-microsecond range, making it suitable for measurement and control systems. Chrony, a popular alternative to ntpd, that comes shipped with Red Hat 7 distribution and is also available in the Ubuntu repositories. It supports synchronization with both PTP as well as NTP and is faster synchronizing, more stable and more accurate in ntpd.

All nodes in a cluster are periodically committed and each commit results in new data version or snapshot. The snapshot can be a FULL backup snapshot, a complete rendering of the data. Or it can be an INCremental backup snapshot, a rendering of difference between last full snapshot of the previous commit and current data. Alternately, it can Delta backup snapshot, a rendering of difference between last full or incremental snapshot of the previous commit and current data.

If the data storage composes of individual immutable data files on a file system, the file can be hard-linked (equivalent to snapshot as data files are immutable) and these hard-links can have copied given parent file system supports hard-linking. Such operations are common for distributed databases of Cassandra family. Ref-links are different from the hard links. While both have different inodes that share same disk blocks, hard links can be taken as different names for the same file while ref-links cannot. For incremental snapshot images, only the new immutable files created since last full snapshot copied to the new file system and for delta snapshot images, only the new immutable files created since the last snapshot copied to the new file system.

Snapshotting or cloning of consisted hash of the ring at the time of snapshot is also required. The ring partition information or the consistent hash can be obtained from any of the coordinator node or the partitioner of the ring. A partitioner determines how data is distributed across the nodes in the cluster (including replicas). Basically, a partitioner is a function for deriving a token representing a row from its partition key, typically by hashing. Each row of data is then distributed across the cluster by the value of the token. Popular partitioners are Murmur3 Partitioner and Random Partitioner use tokens to help assign equal portions of data to each node and evenly distribute data.

In some distributed consistent hashing systems, Snapshotting and Cloning 203 of a node takes time and disturbs the incoming traffic requests especially when file system does not support snapshot or when file system payload is not immutable. When a single node goes out of service for a snapshot, the availability is not affected as requests are transferred to the alternate replicas. So, for such system, NTP/PTP synchronized distributed snapshotting with Synchronization Service 103 is not possible and snapshots need to be taken node by node. Unsynchronized Distributed Snapshotting does not provide a global distributed state, but it can be taken care by replaying some extra traffic from the point of time of the starting of the first node to snapshot and handling duplicate mutations like double write, update or delete. Alternately, there are distributed snapshot algorithms that can provide the consistent global state. The Chandy-Lamport algorithm is a popular distributed snapshotting algorithm for recording a consistent global state of an asynchronous distributed system without affecting the incoming traffic. It uses process markers and channels for communication between the snapshotting processes on each node. Nodes can communicate with binary communication protocols like Apache Thrift or Google Protocol Buffers or Apache Avro. A consistent global state is one corresponding to a consistent cut. A consistent cut is left closed under the causal precedence relation i.e. if one event belongs to a cut, and all events happened before this event also belongs to the cut, then the cut is consistent.

In the Backup subsystem, Data Dereplicator 204 is used to reduce the data replica count to 1. Every distributed storage replication module or the replicator that is responsible for maintaining a replica count equal to the Replication Factor for the cluster. When the replication factor is increased, it increases the number of replicas in load balancing manner and when the replication factor is decreased, it gets rids of the extra replicas effectively acting as dereplicator. Due to the high replication factor, there is a lot of data redundancy in the file system snapshots on each node on each node taken by the Snapshotting and Cloning Module 203. The cloned file system images can be mounted on the respective nodes in a separate location and the Data Dereplicator 204 module can remove the data redundancy when running with replication factor configured as 1. The ring partition information or consistent hash at snapshot time obtained from coordinator node is used by the Data Dereplicator 204 to remove the extra replicas of the data.

In the Backup subsystem, Data Deduplicator 205 is used to perform post-process deduplication after Data Dereplication. Data Deduplication is a technique is used to improve storage utilization and can also be applied to network data transfers to reduce the number of bytes that must be sent. In the deduplication process, unique chunks of data, or byte patterns, are identified (called fingerprints) and stored during a process of analysis. As the analysis continues, other chunks are compared to the stored copy and whenever a match occurs, the redundant chunk is replaced with a small reference that points to the stored chunk. During backup, the Data Cluster 101 is the source and Backup Cluster 202 is the target. In post-process deduplication, the new data generated by SCM during cloning is first stored on the storage device and then a process at a later time will analyze the data looking for duplication to ensure high performance. In storage sensitive systems when storage capacity is limited, in-line deduplication can also be used for trading off performance. Deduplication occurring close to the source or the generated cloned data is called source deduplication or client-side deduplication. It is very efficient in saving network bandwidth especially during full snapshot clones and when the Backup Cluster 202 is in the cloud. Dedupeio's dedupe is an accurate, popular, and scalable fuzzy matching, record deduplication and entity-resolution for intelligent chunking and fingerprinting. In Recovery subsystem, Deduplication Recovery 305 is used to recover

In Backup subsystem, Data Differentiator 206 is an optional backup subsystem module to solves the same problem as data deduplication 205 but rather that replying data chunks, it relies on logical file names or hard-link names. Data Differentiator 206 is especially important when data system is a payload on Host File System. It facilitates faster incremental or delta snapshots. In Recovery subsystem, Data Differentiation Rebuilder 306 is used to rebuild the original data that was removed by Data Differentiator 206. Data Differentiation Rebuilder 306 works by copying the file to required replicas and removing the extra hard-links

Backup Process

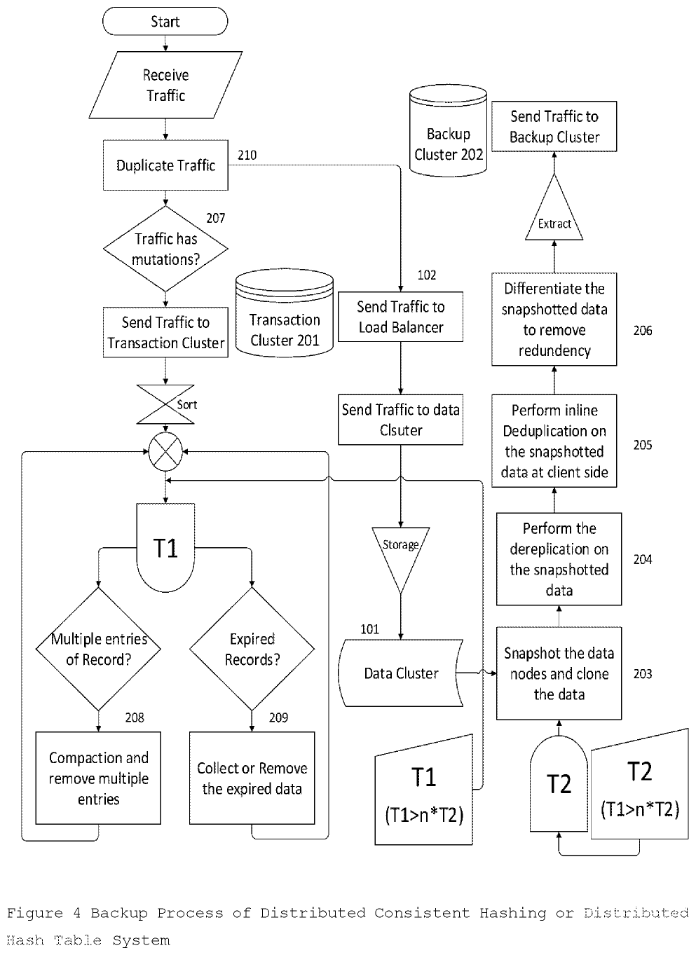

The backup process consists of 2 parallel processes 1. Periodically snapshotting the Data Cluster 101 and copying optimized data to Backup Cluster 202 for course recovery. 2.: Live Traffic recording of mutation traffic as Transactions in Transaction Cluster 201 for accurate and precise recovery. The snapshotting period T2 is period at which Data Cluster 101 and Grace Period T1 is time-to-live (TTL) value set in the Transaction Cluster 201 such that T1>T2 for recovery to work precisely and preferably T1>n*T2 to enable precise recovery in last n snapshotting cycles. FIG. 4 describes the process flow of the Backup Process of Distributed Consistent Hashing or Distributed Hash Table Cluster.

All the nodes in the Data Cluster are in sync by the Synchronization Service 103 and are periodically committed at snapshotting interval T2 by the Snapshotting And Cloning Module 203 (SCM) implemented specifically for the cluster. Each commit results in a Full backup (FBK), Incremental backup (IBK) or Delta backup (DBK) snapshots as desired and explained before.

The Snapshot or cloned file system backup image can be mounted on the respective data nodes in a separate location and the Data Dereplicator 204 module is run on the images with replication factor configured as 1 to remove the data redundancy. After dereplication, Data differentiator 206 is used for payload on Host File System to reduce the number of redundant files by converting them to hard links. It is especially useful in facilitating faster incremental or delta snapshots. After data dereplication and differentiation, Data Deduplicator 205 performs a post-process client-side deduplication to save bandwidth. The Dereplicated backup images on the respective nodes are analyzed by the Data Deduplicator 205 for finding duplication clunks by comparing with the fingerprint from Backup Cluster 202. Then only the changed clunks are sent to the Backup Cluster 202 to save bandwidth and storage. In some distributed systems, snapshotting and cloning of a node takes time and disturbs the incoming traffic requests especially when file system does not support snapshot or when file system payload is not immutable, Unsynchronized Distributed Snapshotting is preferred over the Synchronized Distributed Snapshotting.

All the incoming traffic requests are copied and recorded with a timestamp and mutated object reference by the Traffic Recorder 210 that is integrated inside the Proxy Server 104. The one copy traffic data is sent to the Load Balance 102 as in the original architecture. From the other copy of traffic data, mutation transactions (write, modify, delete) are filtered by Transaction Filter 207 and are sent to the Transaction Cluster 201. All the recorded Transactions are in a defined format or schema with essential fields like mutated object reference, the timestamp, and mutated object value and some additional metadata information. When an object is deleted, the corresponding transaction is marked deleted. A single object in a Transaction Cluster 201 can have multiple object values at different timestamps. Transaction Compactor 208 compacts these multiple values of an object to a single value with the latest timestamp value as the winner, simplifying records and reducing cluster size. All the recorded transactions by Transaction recorder 203 are set to expire after a specific time generally in multiple of snapshotting interval, called GC grace value or TTL value. Transactions are also marked expired by Transaction Compactor 208 during the Transaction compaction. Transaction Collector 209 compacts away old, GC/TTL expired transactions periodically at specialized triggers for better performance.

Recovery Architecture

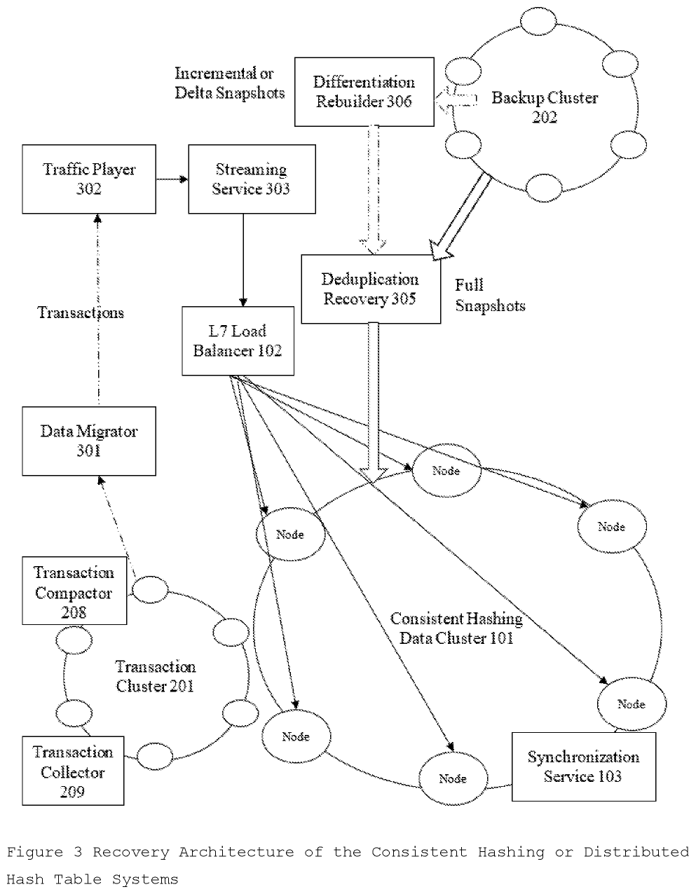

The Recovery subsystem consists of all 3 Clusters, Data Cluster 101, Transaction Cluster 201, and the Backup Cluster 202. It has components like Data Migrator 301, Traffic Player 302 and Streaming Service 303, that are only present on the recovery path. Other components like Deduplication Recovery 305 and Differentiation Rebuilder 306 in the recovery subsystem, are counter components of Deduplicator 205 and Differentiator 206 in the backup subsystem respectively and are already discussed in the backup architecture. FIG. 3 describes the Recovery Architecture in the Distributed Consistent Hashing or Distributed Hash Table Cluster.

In the Recovery subsystem, Data Migrator 301 is used to stream the Transaction data back in the Data Cluster 101. There are plenty of data migration tools and ETL solutions available depending upon the Data Cluster 101 or database product used in Transaction Cluster 201 developed by open source community and tried-party companies like Informatica, Microsoft. Apache Flume is a distributed, reliable, and available service for efficiently collecting, aggregating, and moving large amounts of data. Flume is a great tool to migrate data from RPC (Avro and Thrift native), sequential log files, JMS, Kafka, and Netcat/TCP sources. Apache Sqoop is a connectivity tool for migrating data from data stores such as relational databases and data warehouses into Hadoop. It allows moving data from any kind of relational database system that has JDBC connectivity like Teradata, Oracle, MySQL Server, Postgres or any other JDBC database. Sqoop can also import data from NoSQL databases like MongoDB or Cassandra. Logstash is a server-side data processing pipeline that ingests data from a multitude of sources simultaneously, transforms it, and then sends it to the required destination. The collection is accomplished via configurable input plugins including raw socket/packet communication, file tailing, and several message bus clients and has over 200 plugins supporting multiple sources. Fluentd is another cross-platform open source data collection software project originally developed at Treasure Data. It supports a long list of Data Sources.

In the Recovery subsystem, Transaction Player 302 is used to replay the stored transactions as mutation traffic, and the Streaming Service 303 is used to stream the traffic at desired rate There are multiple streaming solutions available to the stream the data coming from Transaction Cluster 201 back to the Data Cluster 101. In some embodiments, Data Migrator 301, Traffic Player or the Transaction Player 302, and Streaming Service 303 can be one or more components. For example, Kafka can act as both Data Migrator 301 and Streaming Service 303. Apache Kafka is a popular stream-processing software platform that provides a unified, high-throughput, low-latency platform for handling real-time data feeds. LinkedIn initially developed it. Its storage layer is a “massively scalable pub/sub message queue architected as a distributed transaction log. In Kafka, the streaming parallelism is equal to the number of partitions for a topic. The traffic can be divided into topics using the object's meta information, where two topics are logically independent. In each topic, traffic is divided into multiple partitions where streaming is in parallel between partitions and in order of the timestamp in a single partition. Kafka only provides a total ordered streaming of messages within a partition of the topic and does not guaranty in order delivery on a topic. Both topics and partition provide parallelism for the replay. Flink provides another high-throughput, low-latency streaming engine as well as support for event-time processing and state management. Flink applications are fault-tolerant in the event of machine failure and support exactly-once semantics. Flink supports both event time and out-of-order processing in the DataStream API. Apache Apex is a YARN-native platform that unifies stream and batch processing. It processes big data-in-motion in a way that is scalable, performant, fault-tolerant, stateful, secure, distributed, and easily operable. It supports input and output operations to sources and sinks such as HDFS, S3, NFS, FTP, Kafka, ActiveMQ, RabbitMQ, JMS, Cassandra, MongoDB, Redis, HBase, CouchDB, generic JDBC, and other database connectors. Apache Storm is a distributed stream processing computation framework developed by Twitter.

Recovery Process

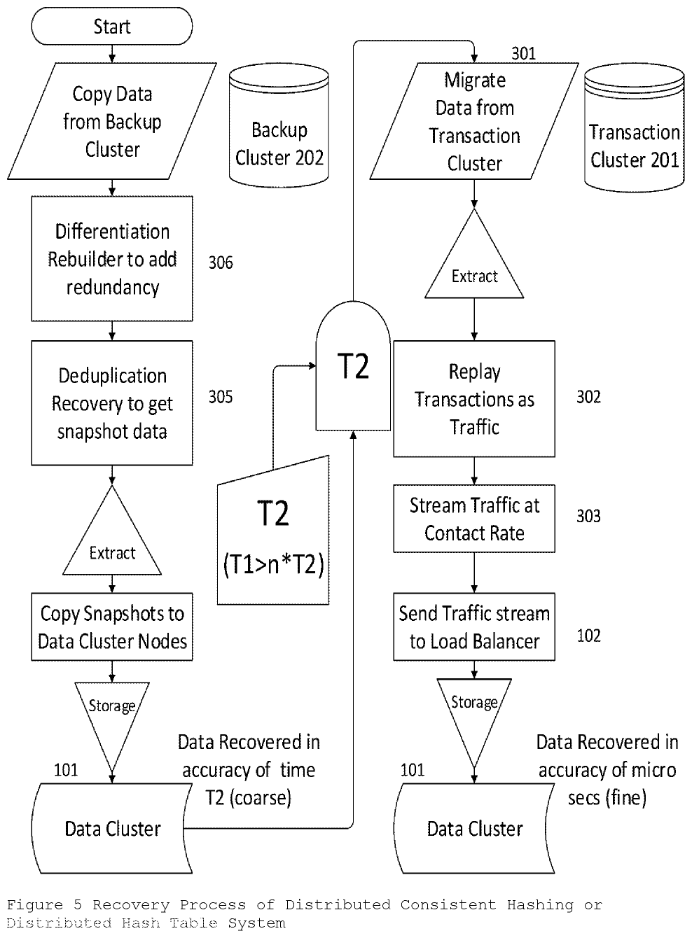

After a crash, the new traffic cannot be served until the Data Cluster 101 is reverted to the desired point-in-time and cluster is put in the maintenance mode and traffic is stopped. The recovery process consists of two parts 1. Finding and restoring or recovering the cluster to the nearest past snapshot before the desired point-in-time. 2 Redoing or Replaying all the transactions from the Transaction Cluster 201 after the snapshot to the selected point-in-time. FIG. 5 describes the process flow of the Recovery Process of Distributed Consistent Hashing or Distributed Hash Table Cluster.

Once the desired point-in-time is selected to recover to, the nearest past snapshot point is identified in the Backup Cluster 202. If it is a full backup, it can be directly restored. In case of incremental backup, it is combined with last full backup to create a current full backup image. In case of delta backup, the snapshot image is combined with all delta backup images till the last full backup image and the last full backup image to create a current full backup image. The restore system is required to have the same number of nodes as the number of nodes when the snapshot was taken. In case of recovery, source and targets are reversed i.e. Backup Cluster 202 is the source and the Data Cluster 101 is target and rest of the architecture is similar to the Backup Architecture.

Differentiation Rebuilder 306 is used to restore the original number of the files that were reduced by Data Differentiator 206 after data is copied to data nodes In Data Cluster 101. After that, Data Deduplicator Recovery 305 performs the server side (the Data Cluster 101 side) deduplication restore to remove the deduplication done by Data Deduplicator 205 during the backup. Once all nodes are reverted to the images, the internal services should be started. The Replicator service on the data nodes in the Data Cluster 101 will increase the replica count from 1 to the replication factor for the cluster as during backup process replication factor was reduced to 1 by Data Dereplicator 204. There is a small added delay of time T3(T3<T2), to make sure Data Cluster replicas are restored and next recovery steps can we started. After this step, the Data Cluster 101 is restored back to restore accuracy in time T2 from the desired point-in-time of restore and so the coarse recovery is complete.

The accurate recovery of the Data Cluster is possible only in time duration T1 which is chosen to greater than a multiple (n) of the snapshotting period (time T2). So, we can do accurately in last n snapshot cycles and past that we are capable of only doing coarse recovery. After the snapshot recovery is complete (after wait time T3<T2), Data Migrator 301 is used to selective migrate data between last recovered snapshot time and desired point-in-time for recovery from the Transaction Cluster 201. Data Migrator 301 is implemented depending upon the type of storage product used in Transaction Cluster 201. All the transactions in the Transaction Cluster 201 are already optimized to remove any duplicate and unwanted paths for object values and the expired values past time T1 (T1>n*T2). The migrated data is feed to the Transaction Player 302 which transforms the Transactions back to the original Traffic (requests) format. Streaming Module 303 is Message Oriented Middleware (MOM) service to reliably transfer the requests to the load balancer 102. Load Balancer 102 then sends the traffic to the data nodes of the Data Cluster 101 in a load balancing way completing the ETL loop. The traffic can be divided into topics by the Streaming Module 303 using the object's meta information, where two topics are logically independent. In each topic, traffic is divided into multiple partitions where streaming is in parallel between partitions and in order of the transaction timestamp in a single partition.

We claim:

1. The claim includes design of distributed, and modular backup and recovery architecture for consistent hashing systems with decoupled Transaction Database Cluster and Backup Cluster and with most components generic in nature making it compatible with a variety of consistent hashing system implementations as shown in FIG. 1.

2. The design of distributed backup system in claim 1 comprising following components in the order as shown in FIG. 2:
the Traffic Recorder component that duplicate incoming traffic;
the Transaction Filter component to filter out the mutation (write, modify, delete) traffic and transform it to the transaction format to be stored in Transaction Database Cluster;
the Transaction Compactor and Transaction Collection components for the simplification of the Transaction to allows the solution to have very low Recovery Time;
the storage-specific snapshotting system Snapshotting and Cloning Module (SCM) to quick snapshotting followed by slow cloning;
the Data Dereplicator system to reduce the number of replicas and its implementation to reduce the number of replicas sent to the backup cluster.

3. The design of a recovery system with the components in order as shown in FIG. 3 and with a Transaction Player component that transforms the transaction back to request from to recover accurately in a specified point in time.
